(19) United States
(12) Patent Application Publication
(10) Pub. No.: US 2024/0014705 A1
(43) Pub. Date: Jan. 11, 2024

(54) Electric Axial Flux Machine, And Axle Comprising An Electric Drive

(71) Applicant: Schaeffler Technologies AG & Co. KG, Herzogenaurach (DE)

(72) Inventors: Vitali REH, Nürnberg (DE); Christian LUTZ, Creußen (DE); Tom HILLMAN, Radley - Oxford (GB); Tim WOOLMER, Markyate (GB)

(21) Appl. No.: 18/265,222

(22) PCT Filed: Nov. 9, 2021
(86) PCT No.: PCT/DE2021/100890

§ 371 Date: Jun. 2, 2023

(30) Foreign Application Priority Data
Dec. 7, 2020 (DE) 10 2020 132 490.1

(51) Int. Cl. H02K 5/20; H02K 9/19; H02K 21/24

(52) U.S. Cl. CPC H02K 5/203; H02K 9/19; H02K 21/24; B60K 11/02

(57) ABSTRACT

The invention relates to an electric axial flux machine comprising a stator, a rotor having a rotor shaft and at least a first disk-shaped rotor body that is rotationally and linearly fixedly arranged on the rotor shaft, and comprising a cooling device for cooling the axial flux machine. According to the invention, the cooling device comprises a first cooling channel module for holding a coolant, said cooling channel module being designed such that is can be placed as a separate component axially directly adjacent to the rotor body, on the side remote from the stator.

The present invention relates to an electric axial flux machine including a stator, a rotor with a rotor shaft and at least a first disk-shaped formed rotor body rotationally fixedly and non-displaceably arranged on the rotor shaft, as well as a cooling device for cooling the axial flux machine. Further, the invention relates to a so-called electric axle or electrically driven axle with integrated electric axial flux machine.

From DE 10 2014 222 121 A1, an electric axial flux machine is known, which comprises a stator with radially extending grooves, and the stator further comprises layers of a spirally extending band-shaped sheet arranged one above the other in radial direction. Therein, the stator comprises a channel-like cavity in its interior for guiding cooling fluid for cooling the stator.

Moreover, a further axial flux machine is described in EP 2 396 871 B1, which comprises a stator with a cooling device.

The invention is based on the object to provide an axial flux machine with a cooling device, which is further optimized with regard to heat inputs due to maximally admissible permanent load. In particular, other components of the axial flux machine are to be adversely effected as little as possible by the construction of the cooling device.

The object underlying the invention is solved by an electric axial flux machine with the features of claim 1 as well as by an electrically drivable axle for a motor vehicle with the features of claim 12.

An axial flux machine according to the invention includes a stator, a rotor with a rotor shaft and with at least a first disk-shaped formed rotor body rotationally fixedly and non-displaceably arranged on the rotor shaft, as well as a cooling device for cooling the axial flux machine. According to the invention, the cooling device includes a first cooling channel module for accommodating a coolant, wherein the cooling channel module is formed as a separate component capable of being arranged axially immediately adjacent to the rotor body on the side facing away from the stator. Hereby, an axial flux machine with a cooling device is provided, which can be simply produced and be introduced into present installation spaces of axial flux machines or be conceived for corresponding installation spaces in axial flux machines to be constructed.

First, the individual elements of the claimed inventive subject matter are explained and particularly preferred configurations of the inventive subject matter are described below.

The magnetic flux in an electric axial flux machine (AFM), such as for example an electric drive machine of a motor vehicle formed as an axial flux machine, is axially oriented to a rotational direction of the rotor of the axial flux machine in the air gap between stator and rotor. There are different types of axial flux machines. A known type is a so-called I arrangement, in which the rotor is axially arranged next to a stator or between two stators. Another known type is a so-called H arrangement, in which two rotors are arranged on opposing axial sides of a stator.

The stator of an electric axial flux machine comprises a stator body with multiple stator windings arranged in circumferential direction. The stator body can be formed in integral or segmented manner viewed in circumferential direction. The stator body can be formed of a stator sheet package with multiple laminated electric sheets. Alternatively, the stator body can also be formed of a pressed soft-magnetic material like the so-called SMC (Soft Magnetic Compound) material.

A rotatably supported shaft of an electric machine is referred to as rotor shaft, to which the rotor or rotor body is rotationally fixedly coupled.

The rotor of an electric axial flux machine can at least partially be formed as a sheeted rotor. A sheeted rotor is formed layered in axial direction. Therein, the axial magnetic flux has to overcome the adhesive or insulation layers between the stacked individual electric sheets, whereby the magnetic circuit experiences a shear (additional air gap) and loses efficiency. Alternatively, the rotor of an axial flux machine can also comprise a rotor carrier, which is correspondingly formed equipped with magnetic sheets and/or SMC material and with magnetic elements formed as permanent magnets.

Advantageous configurations of the invention are specified in the dependently formulated claims. The features individually recited in the dependently formulated claims can be combined with each other in technologically reasonable manner and can define further configurations of the invention. Moreover, the features specified in the claims are defined and explained in more detail in the description, wherein further preferred configurations of the invention are presented.

According to an advantageous configuration of the invention, it can be provided that the cooling channel module is multi-part formed and includes at least one cooling channel element for accommodating the coolant and a base plate for the assembly, wherein the cooling channel element can be arranged on the base plate and wherein the base plate with the cooling channel element can be arranged at a housing wall arranged axially adjacent to the rotor body. The advantage of this configuration is in particular substantiated in the modular construction and the simple assembly.

According to a further preferred development of the invention, it can also be provided that the cooling channel element is formed as a circumferentially non-closed ring or arc or in the form of a horseshoe or a U or the like and comprises a coolant inflow opening at an end and a coolant outflow opening at the other end on its side facing the base plate, and that the base plate comprises channel openings corresponding herewith. Hereby, a constructively simple cooling device optimized with regard to the cooling of the rotors is provided.

Furthermore, it can be provided according to an also advantageous configuration of the invention that the cooling channel element is formed as a flattened ring element, which has an axial thickness, which is smaller dimensioned than its radial thickness. The advantageous effect of this configuration is substantiated in that an optimized cooling surface can be provided in narrow installation space hereby. Hereto, the cooling channel element advantageously has an axial thickness, which measures maximally half of the radial thickness.

Furthermore, the invention can also be further developed to the effect that the base plate and/or the cooling element is/are formed such that the axial air gap between rotor and cooling channel module is dimensioned less than or equal to 3 mm. In particular, the axial air gap between rotor and cooling channel module measures at least 1 mm and at most 2 mm. Thus, a further improved cooling of the axial flux machine with regard to the dissipation of the heat maximally generated in the permanent operation can be achieved.

In an also preferred configuration variant of the invention, it can also be provided that the cooling channel module is integrally formed, which in turn further facilitates the production of the cooling channel module as well as the assembly thereof.

Preferably, the cooling channel module comprises a reservoir for accommodating the coolant, wherein the cooling channel module comprises a coolant inflow opening at the beginning of the reservoir and a coolant outflow opening at the end of the reservoir. Therein, the cooling channel module is arranged in a recess of a housing wall arranged axially adjacent to the rotor body of the axial flux machine such that the coolant inflow opening and the coolant outflow opening within the recess correspond with openings of a coolant inflow channel and a coolant outflow channel formed in the recess. Advantageously, the cooling channel module comprises positioning means on the circumference or on its side facing the housing, which cooperate with corresponding positioning means of the housing or of the recess, such that a unique positioning and fixing of the coolant module within the recess are ensured. The advantage, which can be realized hereby, is in particular the installation space of the electric axial flux machine reduced in axial extension.

Finally, the invention can also be advantageously designed to the effect that the cooling channel module is coupled to a liquid cooling circuit for cooling further components within a motor vehicle. In particular, the cooling channel module is coupled to a liquid cooling circuit for cooling an internal combustion engine within a motor vehicle. Hereby, the required effort for a cooling device of the axial flux machine can be further reduced.

Advantageously, the axial flux machine is formed in H arrangement, with a first disk-shaped formed rotor body rotationally fixedly and non-displaceably arranged on the rotor shaft, and with a second disk-shaped formed rotor body rotationally fixedly and non-displaceably arranged on the rotor shaft, as well as with a stator, which is arranged in the axial center between the two rotor bodies. Therein, the cooling device includes a first cooling channel module for accommodating a coolant, wherein the first cooling channel module is formed as a separate component capable of being arranged axially immediately adjacent to the first rotor body on the side facing away from the stator, and further includes a second cooling channel module for accommodating a coolant, wherein the second cooling channel module is formed analogously to the first cooling channel module as a separate component capable of being arranged axially immediately adjacent to the second rotor body on the side facing away from the stator. Hereby, an axial flux machine in H arrangement further improved with regard to the cooling properties of the rotor bodies can be provided.

Moreover, the object underlying the invention is solved by an electrically drivable axle of a motor vehicle with an integrated axial flux machine as it is formed according to the invention.

Below, the invention as well as the technical environment are explained in more detail based on the figures. It is to be pointed out that the invention is not to be restricted by the shown embodiments. In particular, it is also possible, unless explicitly otherwise presented, to extract partial aspects of the facts explained in the figures and to combine them with other constituents and realizations from the present description and/or figures. In particular, it is to be pointed out that the figures and in particular the illustrated size ratios are only schematic. Identical reference characters denote identical items such that explanations from other figures can optionally be additionally used.

There show:

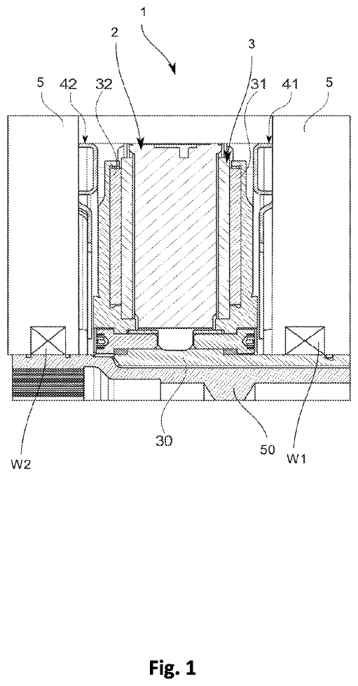

FIG. 1 an axial flux machine according to the invention, integrated in an axle of a motor vehicle, in a partial axial section in schematic representation,

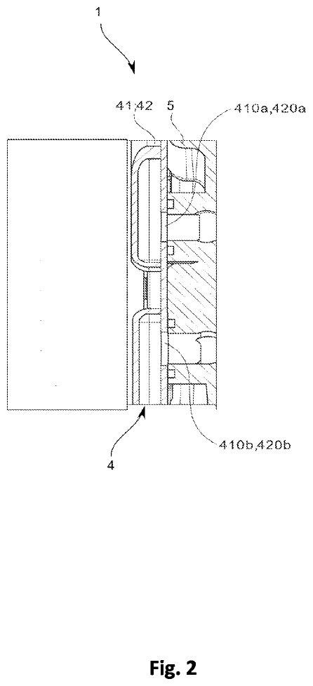

FIG. 2 an enlarged representation of a detail partial section of the axial flux machine according to FIG. 1, and

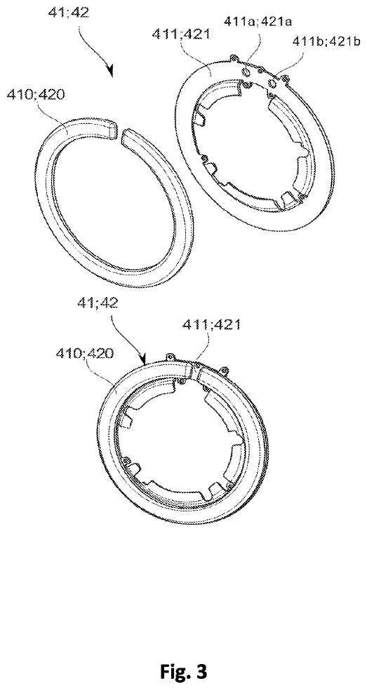

FIG. 3 a two-part formed cooling channel module, in an exploded representation at the top and in a perspective view at the bottom.

FIG. 1 shows an axial flux machine 1 according to the invention in a partial axial section in schematic representation. The shown electric axial flux machine 1 includes an axially centrally arranged stator 2, a rotor 3 with a rotor shaft 30 and with a first disk-shaped formed rotor body 31 rotationally fixedly and non-displaceably arranged on the rotor shaft 30 on a side axially adjacent to the stator 2, as well as with a second disk-shaped formed rotor body 32 rotationally fixedly and non-displaceably arranged on the rotor shaft 30 on the axially opposing side of the stator 2. Therein, the rotor shaft 30 is configured as a hollow shaft, wherein an output shaft 50 protrudes within the hollow shaft at least in certain areas, which is coupled to the rotor shaft 30 via a toothing (external toothing of the output shaft and corresponding internal toothing of the rotor shaft 30) for transferring a torque. In the illustrated example, the rotor shaft 30 is arranged rotatably supported in a housing wall 5 via a roller bearing W1 on the one side and is arranged supported in a housing wall 5 via a further roller bearing W2 on the opposing axial side of the output shaft 50. Further, the illustrated axial flux machine 1 includes a cooling device 4 with a first cooling channel module 41 for accommodating a coolant and with a second cooling channel module 42, wherein each cooling channel module 41, 42 is formed as a separate component capable of being arranged axially immediately adjacent to the respective rotor body 31, 32 each on the side facing away from the stator 2. Preferably, the cooling channel module 41, 42 is respectively multi-part formed (see FIG. 3, at the top) and includes at least one cooling channel element 410, 420 for accommodating the coolant and a base plate 411, 421. Therein, the cooling channel element 410, 420 is each arranged on the base plate 411, 421 associated with it for the purpose of the assembly to a housing wall 5 of a housing, wherein the base plate 411, 421 with the cooling channel element 410 can be arranged at a housing wall 5 arranged axially adjacent to the rotor body 31.

FIG. 2 shows an enlarged representation of a detail partial section of the axial flux machine 12 according to FIG. 1. In the shown representation of FIG. 2 in connection with the representation in FIG. 3, it is well apparent that the cooling channel element 410, 420 is each formed as a circumferentially non-closed ring and comprises a coolant inflow opening 410a, 420a at one end and a coolant outflow opening 410b, 420b at the other end on its side facing the base plate 411, 421, and that the base plate 411, 421 comprises channel openings 411a, 411b corresponding herewith. As illustrated in the FIGS. 2 and 3, the cooling channel element 410 is formed as a flattened ring element, which has an axial thickness, which is smaller dimensioned than its radial thickness.

FIG. 3 shows the cooling channel module 41, 42 as a two-part formed assembly, wherein the assembly is illustrated in an exploded representation at the top and in a perspective view at the bottom.

The invention is not restricted to the embodiments illustrated in the figures. Therefore, the above description is not to be regarded as restrictive, but as illustrative. The following claims are to be understood such that a mentioned feature is present in at least one embodiment of the invention. This does not exclude the presence of further features. If the claims and the above description define “first” and “second” features, thus, this designation serves for distinguishing two similar features without setting a rank order.

### LIST OF REFERENCE CHARACTERS

1 Axial flux machine
2 stator
3 rotor
30 rotor shaft
31 first rotor body
32 second rotor body
4 cooling device
41 first cooling channel module
410 cooling channel element
410a coolant inflow opening
410b coolant outflow opening
411 base plate
42 second cooling channel module
420 cooling channel element
420a coolant inflow opening
420b coolant outflow opening
421 base plate
W1 roller bearing
W2 roller bearing

1. An electric axial flux machine, comprising
a stator,
a rotor with a rotor shaft and with at least a first disk-shaped formed rotor body rotationally fixedly and non-displaceably arranged on the rotor shaft, and
a cooling device for cooling the axial flux machine,
wherein the cooling device includes a first cooling channel module for accommodating a coolant, and wherein the cooling channel module is formed as a separate component capable of being arranged axially immediately adjacent to the rotor body on the side facing away from the stator.

2. The axial flux machine according to claim 1,
wherein the cooling channel module is multi-part formed and includes at least one cooling channel element for accommodating the coolant and a base plate,
wherein the cooling channel element can be arranged on the base plate and
wherein the base plate with the cooling channel element can be arranged at a housing wall arranged axially adjacent to the rotor body.

3. The axial flux machine according to claim 2,
wherein the cooling channel element is formed as a circumferentially non-closed ring or arc and comprises a coolant inflow opening at an end and a coolant outflow opening at the other end on its side facing the base plate, and that the base plate comprises channel openings corresponding herewith.

4. The axial flux machine according to claim 1,
wherein the cooling channel element is formed as a flattened ring element, which has an axial thickness, which is smaller dimensioned than its radial thickness.

5. The axial flux machine according to claim 4,
wherein the cooling channel element has an axial thickness, which measures maximally half of the radial thickness.

6. The axial flux machine (1) according to claim 1,
wherein the base plate and/or the cooling element is/are formed such that the axial air gap between rotor and cooling channel module is dimensioned less than or equal to 3 mm, in particular that the axial air gap between rotor and cooling channel module measures at least 1 mm and at most 2 mm.

7. The axial flux machine according to claim 1,
wherein the cooling channel module is integrally formed.

8. The axial flux machine according to claim 7,
wherein the cooling channel module comprises a reservoir for accommodating the coolant, wherein the cooling channel module comprises a coolant inflow opening at the beginning of the reservoir and a coolant outflow opening at the end of the reservoir, and that the cooling channel module is arranged in a recess of a housing wall arranged axially adjacent to the rotor body of the axial flux machine, such that the coolant inflow opening and the coolant outflow opening within the recess correspond with openings of a coolant inflow channel and a coolant outflow channel formed in the recess.

9. The axial flux machine according to claim 8,
wherein the cooling channel module comprises positioning means on the circumference or on its side facing the housing, which cooperate with corresponding positioning means of the housing or of the recess, such that a unique positioning of the coolant module within the recess is ensured.

10. The axial flux machine according to claim 1,
wherein the cooling channel module is coupled to a liquid cooling circuit for cooling further components within a motor vehicle, in particular coupled to a liquid cooling circuit for cooling an internal combustion engine within a motor vehicle.

11. The axial flux machine according to claim 1,
wherein the axial flux machine is formed in H arrangement with a first disk-shaped formed rotor body rotationally fixedly and non-displaceably arranged on the rotor shaft and with a second disk-shaped formed rotor body rotationally fixedly and non-displaceably arranged on the rotor shaft, wherein the cooling device includes a first cooling channel module for accommodating a coolant, wherein the first cooling channel module is formed as a separate component capable of being arranged axially immediately adjacent to the first rotor body on the side facing away from the stator, and wherein the cooling device includes a second cooling channel module for accommodating a coolant, wherein the second cooling channel module is formed as a separate component capable of being arranged axially immediately adjacent to the second rotor body on the side facing away from the stator.

12. An electrically drivable axle for a motor vehicle, the axle including an electric axial flux machine,
the axial flux machine comprising a stator, a rotor having a rotor shaft and at least a first disk-shaped formed rotor body rotationally fixedly and non-displaceably arranged on the rotor shaft, and a cooling device for cooling the axial flux machine,
wherein the cooling device includes a first cooling channel module for accommodating a coolant, and wherein the cooling channel module is formed as a separate component capable of being arranged axially immediately adjacent to the rotor body on the side facing away from the stator.
